(19) United States
(12) Patent Application Publication
(10) Pub. No.: US 2026/0100572 A1
(43) Pub. Date: Apr. 9, 2026

(54) RECEIVER PROTECTION DEVICE

(71) Applicant: REALTEK SEMICONDUCTOR CORPORATION, HSINCHU (TW)

(72) Inventor: TSUNG-YEN LIU, HSINCHU (TW)

(21) Appl. No.: 19/349,000

(22) Filed: Oct. 3, 2025

(30) Foreign Application Priority Data
Oct. 8, 2024 (TW) 113138343

(51) Int. Cl. H02H 3/20

(52) U.S. Cl. CPC H02H 3/20

(57) ABSTRACT

A receiver protection device includes a bias circuit and a first protection circuit. The bias circuit receives an input voltage, and generates a plurality of bias voltages according to the input voltage. The first protection circuit includes a first control transistor, a first diode, and a first protection transistor. The first control transistor receives a power supply voltage, provides the power supply voltage or a low-level voltage to be a first control voltage according to a first bias voltage of the bias voltages, and provides the first control voltage to a first node. The first diode provides a first output voltage to the first node according to a second bias voltage of the bias voltages. The first protection transistor receives the input voltage, and provides the input voltage or the low-level voltage to be a protection voltage according to a first voltage of the first node.

### BACKGROUND OF THE INVENTION

### 1. Field of the Invention

The present disclosure relates to a receiver protection device, especially to a receiver protection device for preventing input voltage distortion.

### 2. Description of Related Art

A protection circuit of a general receiver utilizes multiple metal-oxide-semiconductor field-effect transistors (MOSFETs) as protection elements to prevent the receiver from being damaged due to an excessive input voltage. However, the protection circuit utilizing MOSFETs may limit the input voltage, thereby causing distortion of the input voltage.

### SUMMARY OF THE INVENTION

In some aspects, an object of the present disclosure is to, but not limited to, provides a receiver protection device that makes an improvement to the prior art.

An embodiment of a receiver protection device includes a bias circuit and a first protection circuit. The bias circuit is configured to receive an input voltage, and generate a plurality of bias voltages according to the input voltage. The first protection circuit includes a first control transistor, a first diode, and a first protection transistor. The first control transistor is configured to receive a power supply voltage, provide the power supply voltage or a low-level voltage to be a first control voltage according to a first bias voltage of the plurality of bias voltages, and provide the first control voltage to a first node. The first diode is configured to provide a first output voltage to the first node according to a second bias voltage of the plurality of bias voltages. The first protection transistor is configured to receive the input voltage, and provide the input voltage or the low-level voltage to be a protection voltage according to a first voltage of the first node.

Technical features of some embodiments of the present disclosure make an improvement to the prior art. The receiver protection device of the present disclosure can prevent distortion of the input voltage. In addition, the receiver protection device of the present disclosure can protect its internal components (e.g., transistors) from being damaged due to an excessive cross-voltage. Furthermore, when the input voltage is present while the power supply voltage is absent, the control transistor is turned off due to the same voltage at its two terminals, and thus the voltage will not backfeed to the power supply voltage path.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 shows an embodiment of a receiver protection device of the present disclosure.

FIG. 2 shows an embodiment of an input/output circuit, a receiver protection device, and a receiver of the present disclosure.

### DETAILED DESCRIPTION OF THE PREFERRED EMBODIMENTS

To address the issue of input voltage distortion caused by the protection circuit in the prior art, the present disclosure provides a receiver protection device, which will be explained in detail as shown below.

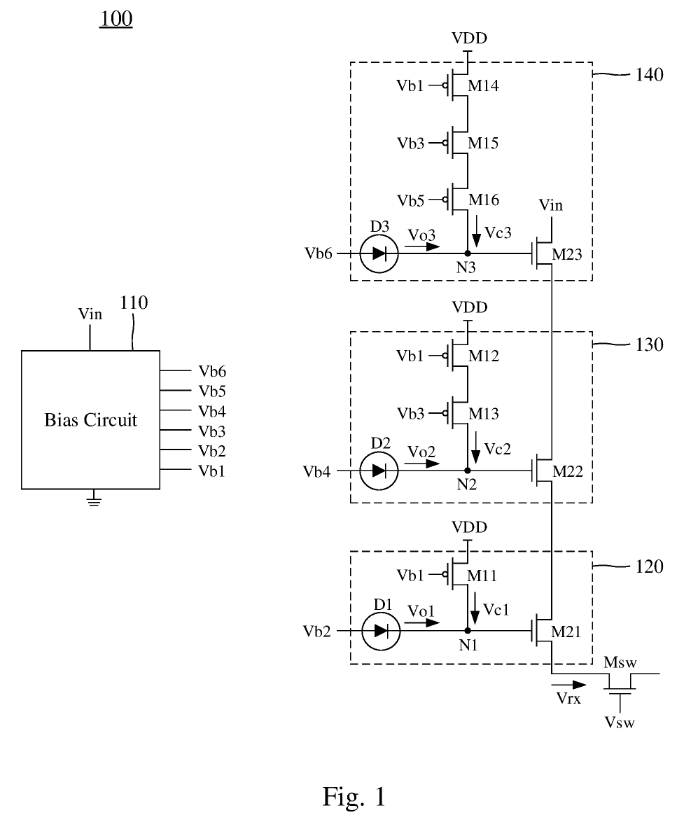

FIG. 1 shows an embodiment of a receiver protection device 100 of the present disclosure. As shown in the figure, the receiver protection device 100 includes a bias circuit 110, a first protection circuit 120, a second protection circuit 130, and a third protection circuit 140. Structurally, the bias circuit 110 is coupled to the first protection circuit 120, the second protection circuit 130, and the third protection circuit 140. The first protection circuit 120 is coupled to the second protection circuit 130. The second protection circuit 130 is coupled to the third protection circuit 140.

In some embodiments, the bias circuit 110 is configured to receive an input voltage Vin, and generate a plurality of bias voltages (e.g., a first bias voltage Vb1 to a sixth bias voltage Vb6) according to the input voltage Vin. For example, the bias circuit 110 can be formed of multiple resistors to divide the input voltage Vin into multiple bias voltages (e.g., the first bias voltage Vb1 to the sixth bias voltage Vb6). In some embodiments, the magnitude of the input voltage Vin ranges from 0 V (volt) to 5.5 V, and the voltage magnitudes of the first bias voltage Vb1 to the sixth bias voltage Vb6 sequentially increase from low to high. For example, the first bias voltage Vb1 can be 0.8 V, the second bias voltage Vb2 can be 1.6 V, the third bias voltage Vb3 can be 2.4 V, the fourth bias voltage Vb4 can be 3.2 V, the fifth bias voltage Vb5 can be 4 V, and the sixth bias voltage Vb6 can be 4.8 V. It should be noted that the present disclosure is not limited to the above embodiment, which is merely for illustrative purposes. In other embodiments, the input voltage Vin and the first bias voltage Vb1 to the sixth bias voltage Vb6 can be other appropriate values, depending on actual requirements.

In some embodiments, the first protection circuit 120 includes a first control transistor M11, a first diode D1, and a first protection transistor M21. Structurally, the first control transistor M11, the first diode D1, and the first protection transistor M21 are coupled to a first node N1.

Referring to FIG. 1, the first control transistor M11 is configured to receive a power supply voltage VDD, provide the power supply voltage VDD or a low-level voltage to be a first control voltage Vc1 according to the first bias voltage Vb1 of the plurality of bias voltages Vb1 to Vb6, and provide the first control voltage Vc1 to the first node N1. The first diode D1 is configured to provide a first output voltage Vo1 to the first node N1 according to the second bias voltage Vb2 of the plurality of bias voltages Vb1 to Vb6. The first protection transistor M21 is configured to receive the input voltage Vin, and provide the input voltage Vin or a low-level voltage to be a protection voltage Vrx according to the first voltage (e.g., the first control voltage Vc1 and/or the first output voltage Vo1) of the first node N1.

For example, the first control transistor M11 receives a power supply voltage VDD of 1.8 V, and provides the power supply voltage VDD of 1.8 V or a low-level voltage of 0 V to be the first control voltage Vc1 according to the first bias voltage Vb1, and provides the first control voltage Vc1 to the first node N1. Additionally, the first diode D1 is configured to provide the first output voltage Vo1 of 0.8 V to the first node N1 according to the second bias voltage Vb2 of 1.6 V. If the first output voltage Vo1 of 0.8 V is the same as the first bias voltage Vb1 of 0.8 V, the first control transistor M11 is turned off, and the voltage will not backfeed to the power supply voltage VDD path. Furthermore, the first protection transistor M21 receives the input voltage Vin, and provides the input voltage Vin or a low-level voltage of 0 V to be the protection voltage Vrx according to the first voltage (e.g., the first control voltage Vc1 and/or the first output voltage Vo1) of the first node N1. The switch circuit Msw can subsequently determine whether to provide the protection voltage Vrx to the receiver (not shown).

In some embodiments, the voltage difference between the power supply voltage VDD and the first bias voltage Vb1 is less than the power supply voltage VDD. For example, according to the circuit design of the present disclosure, the voltage difference between the power supply voltage VDD of 1.8 V and the first bias voltage Vb1 of 0.8 V is approximately 1 V. This voltage difference of 1V is less than the power supply voltage VDD of 1.8 V, thereby preventing a cross-voltage of the first control transistor M11 from exceeding the power supply voltage VDD of 1.8 V and causing damage to the first control transistor M11. It should be noted that the present disclosure is not limited to the above embodiment, which is merely for illustrative purposes. In other embodiments, the power supply voltage VDD and the first bias voltage Vb1 can be other appropriate values, depending on actual requirements.

In some embodiments, the second protection circuit 130 includes a second control transistor M12, a third control transistor M13, a second diode D2, and a second protection transistor M22. Structurally, the third control transistor M13, the second diode D2, and the second protection transistor M22 are coupled to a second node N2. In addition, the second control transistor M12 and the third control transistor M13 are connected in series.

Please refer to FIG. 1. The second control transistor M12 is configured to receive the power supply voltage VDD, and provide the power supply voltage VDD or a low-level voltage to be a second control voltage Vc2 according to the first bias voltage Vb1 of the plurality of bias voltages Vb1 to Vb6. The third control transistor M13 is configured to receive the second control voltage Vc2, and provide the second control voltage Vc2 to the second node N2 according to the third bias voltage Vb3 of the plurality of bias voltages Vb1 to Vb6. The second diode D2 is configured to provide a second output voltage Vo2 to the second node N2 according to the fourth bias voltage Vb4 of the plurality of bias voltages Vb1 to Vb6. The second protection transistor M22 is configured to receive the input voltage Vin, and provide the input voltage Vin or a low-level voltage to be the protection voltage Vrx according to a second voltage (e.g., the second control voltage Vc2 and/or the second output voltage Vo2) of the second node N2.

For example, the second control transistor M12 receives the power supply voltage VDD of 1.8V, and provides the power supply voltage VDD of 1.8V or a low-level voltage of 0V to be the second control voltage Vc2 according to the first bias voltage Vb1. The third control transistor M13 receives the second control voltage Vc2, and provides the second control voltage Vc2 to the second node N2 according to the third bias voltage Vb3. Additionally, the second diode D2 provides the second output voltage Vo2 of 2.4V to the second node N2 according to the fourth bias voltage Vb4 of 3.2V. If the second output voltage Vo2 of 2.4V is the same as the third bias voltage Vb3 of 2.4V, the third control transistor M13 is turned off, and voltage will not backfeed to the power supply voltage VDD path. Furthermore, the second protection transistor M22 receives the input voltage Vin, and provides the input voltage Vin or a low-level voltage of 0V to be the protection voltage Vrx according to the second voltage (e.g., the second control voltage Vc2 and/or the second output voltage Vo2) of the second node N2. The switch circuit Msw can subsequently determine whether to provide the protection voltage Vrx to the receiver (not shown).

In some embodiments, the first voltage difference between the power supply voltage VDD and the first bias voltage Vb1 is less than the power supply voltage VDD, and the second voltage difference between the first bias voltage Vb1 and the third bias voltage Vb3 is less than the power supply voltage VDD. For example, according to the circuit design of the present disclosure, the voltage difference between the power supply voltage VDD of 1.8V and the first bias voltage Vb1 of 0.8V is approximately 1V. This voltage difference of 1V is less than the power supply voltage VDD of 1.8V, thereby preventing a cross-voltage of the second control transistor M12 from exceeding the power supply voltage VDD of 1.8V and causing damage to the second control transistor M12. Additionally, the voltage difference between the first bias voltage Vb1 of 0.8V and the third bias voltage Vb3 of 2.4V is approximately 1.6V. This 1.6V is less than the power supply voltage VDD of 1.8V, thereby preventing a cross-voltage of the third control transistor M13 from exceeding the power supply voltage VDD of 1.8V and causing damage to the third control transistor M13. It should be noted that the present disclosure is not limited to the above embodiment, which is merely for illustrative purposes. In other embodiments, the power supply voltage VDD, the first bias voltage Vb1, and the third bias voltage Vb3 may adopt other suitable values, depending on actual requirements.

In some embodiments, the third protection circuit 140 includes a fourth control transistor M14, a fifth control transistor M15, a sixth control transistor M16, a third diode D3, and a third protection transistor M23. Structurally, the sixth control transistor M16, the third diode D3, and the third protection transistor M23 are coupled to a third node N3. In addition, the fourth control transistor M14, the fifth control transistor M15, and the sixth control transistor M16 are connected in series.

Please refer to FIG. 1. The fourth control transistor M14 is configured to receive the power supply voltage VDD, and provide the power supply voltage VDD or a low-level voltage to be a third control voltage Vc3 according to the first bias voltage Vb1 of the plurality of bias voltages Vb1 to Vb6. The fifth control transistor M15 is configured to receive the third control voltage Vc3, and provide the third control voltage Vc3 according to the third bias voltage Vb3 of the plurality of bias voltages Vb1 to Vb6. The sixth control transistor M16 is configured to receive the third control voltage Vc3, and provide the third control voltage Vc3 to the third node N3 according to the fifth bias voltage Vb5 of the plurality of bias voltages Vb1 to Vb6. The third diode D3 is configured to provide a third output voltage Vo3 to the third node N3 according to the sixth bias voltage Vb6 of the plurality of bias voltages Vb1 to Vb6. The third protection transistor M23 is configured to receive the input voltage Vin, and provide the input voltage Vin or a low-level voltage to be the protection voltage Vrx according to the third voltage (e.g., the third control voltage Vc3 and/or the third output voltage Vo3) of the third node N3.

For example, the fourth control transistor M14 receives the power supply voltage VDD of 1.8V, and provides the power supply voltage VDD of 1.8V or a low-level voltage of 0V to be the third control voltage Vc3 according to the first bias voltage Vb1. The fifth control transistor M15 receives the third control voltage Vc3, and provides the third control voltage Vc3 according to the third bias voltage Vb3. The sixth control transistor M16 receives the third control voltage Vc3, and provides the third control voltage Vc3 to the third node N3 according to the fifth bias voltage Vb5. Additionally, the third diode D3 provides the third output voltage Vo3 of 4V to the third node N3 according to the sixth bias voltage Vb6 of 4.8V. If the third output voltage Vo3 of 4V is the same as the fifth bias voltage Vb5 of 4V, the sixth control transistor M16 is turned off, and voltage does not backfeed to the power supply voltage VDD path. Furthermore, the third protection transistor M23 receives the input voltage Vin, and provides the input voltage Vin or a low-level voltage of 0V to be the protection voltage Vrx according to the third voltage (e.g., the third control voltage Vc3 and/or the third output voltage Vo3) of the third node N3. The switch circuit Msw can subsequently determine whether to provide the protection voltage Vrx to the receiver (not shown).

In some embodiments, a first voltage difference between the power supply voltage VDD and the first bias voltage Vb1 is less than the power supply voltage VDD, a second voltage difference between the first bias voltage Vb1 and the third bias voltage Vb3 is less than the power supply voltage VDD, and a third voltage difference between the third bias voltage Vb3 and the fifth bias voltage Vb5 is less than the power supply voltage VDD. For example, according to the circuit design of the present disclosure, the voltage difference between the power supply voltage VDD of 1.8V and the first bias voltage Vb1 of 0.8V is approximately 1V. This voltage difference of 1V is less than the power supply voltage VDD of 1.8V, thereby preventing a cross-voltage of the fourth control transistor M14 from exceeding the power supply voltage VDD of 1.8V and causing damage to the fourth control transistor M14. Additionally, the voltage difference between the first bias voltage Vb1 of 0.8V and the third bias voltage Vb3 of 2.4V is approximately 1.6V. This 1.6V is less than the power supply voltage VDD of 1.8V, thereby preventing a cross-voltage of the fifth control transistor M15 from exceeding the power supply voltage VDD of 1.8V and causing damage to the fifth control transistor M15. Furthermore, the voltage difference between the third bias voltage Vb3 of 2.4V and the fifth bias voltage Vb5 of 4V is approximately 1.6V. This 1.6V is less than the power supply voltage VDD of 1.8V, thereby preventing a cross-voltage of the sixth control transistor M16 from exceeding the power supply voltage VDD of 1.8V and causing damage to the sixth control transistor M16. It should be noted that the present disclosure is not limited to the above-mentioned embodiment, which is merely for illustrative purposes. In other embodiments, the power supply voltage VDD, the first bias voltage Vb1, the third bias voltage Vb3, and the fifth bias voltage Vb5 may adopt other suitable values, depending on actual requirements.

Please refer to FIG. 1. If the power supply voltage VDD is 1.8V and the input voltage Vin is within a normal range from 0V to 1.1V, then the first node N1 to the third node N3 are all at 1.8V, and the first protection transistor M21, the second protection transistor M22, and the third protection transistor M23 are all turned on. In this condition, the receiver protection device 100 of the present disclosure can successfully receive the input voltage Vin in the range of 0V to 1.1V, and the input voltage Vin experiences almost no loss and thus is not distorted.

Furthermore, if the input voltage Vin is in an overvoltage condition ranging from 5V to 5.5V, regardless of whether the power supply voltage VDD is present, the first node N1 to the third node N3 can each generate appropriate intermediate potentials (e.g., 4V, 2.4V, 0.8V) through voltage division by the bias circuit 110 and processing by diodes D1 to D3. This ensures that each terminal (e.g., gate, drain, source, base) of the control transistors M11 to M16, the protection transistors M21 to M23, and the switch transistor Msw does not exceed the maximum operable voltage. In other words, the internal components of the receiver protection device 100 (e.g., the control transistors M11 to M16, the protection transistors M21 to M23, and the switch transistor Msw) will not be damaged due to an excessive cross-voltage.

Furthermore, when the input voltage Vin is present while the power supply voltage VDD is absent, the control transistors M11, M13, M16 will be turned off due to the same voltage level at both of their terminals. As a result, voltage will not backfeed to the power supply voltage VDD path.

In some embodiments, the first protection transistor M21, the second protection transistor M22, and the third protection transistor M23 are connected in series. In some embodiments, the switch transistor Msw is connected in series with the first protection transistor M21, and provides the protection voltage Vrx or a low-level voltage to the receiver (not shown) according to the switch voltage Vsw.

In some embodiments, the first control transistor M11, the second control transistor M12, the third control transistor M13, the fourth control transistor M14, the fifth control transistor M15, and the sixth control transistor M16 can be P-type metal-oxide-semiconductor field-effect transistors (MOSFETs). The first protection transistor M21, the second protection transistor M22, the third protection transistor M23, and the switch transistor Msw can be N-type metal-oxide-semiconductor field-effect transistors. It should be noted that the present disclosure is not limited to the above embodiment, which is merely for illustrative purposes. In other embodiments, other suitable types of transistors can be used depending on actual requirements.

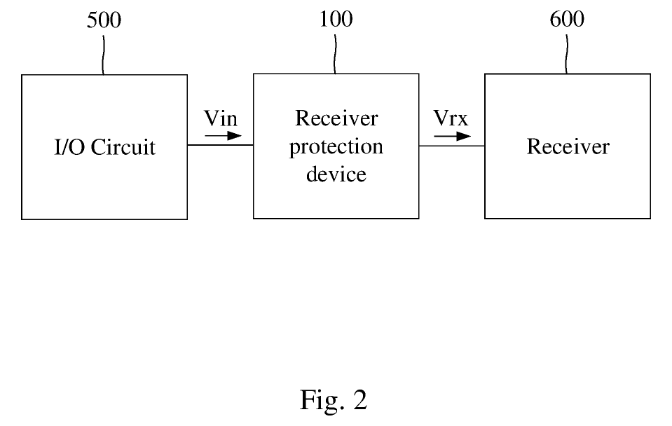

FIG. 2 shows an embodiment of an input/output circuit 500, a receiver protection device 100, and a receiver 600 of the present disclosure. To further facilitate understanding of the overall operation of the present disclosure, please refer to FIG. 2. The input/output (I/O) circuit 500 provides an input voltage Vin to the receiver protection device 100. After the receiver protection device 100 processes the input voltage Vin, the receiver protection device 100 provides a protection voltage Vrx to the receiver 600. As described above, the receiver protection device 100 processes the input voltage Vin to prevent the input voltage Vin from being excessively high and damaging the receiver 600.

It should be noted that the present disclosure is not limited to the embodiments as shown in FIG. 1 to FIG. 2, they are merely examples for illustrating the implements of the present disclosure, and the scope of the present disclosure shall be defined based on the claims as shown below. In view of the foregoing, it is intended that the present disclosure covers modifications and variations to the embodiments of the present disclosure, and modifications and variations to the embodiments of the present disclosure also fall within the scope of the following claims and their equivalents.

Technical features of some embodiments of the present disclosure make an improvement to the prior art. The receiver protection device of the present disclosure can prevent distortion of the input voltage. In addition, the receiver protection device of the present disclosure can protect its internal components (e.g., transistors) from being damaged due to an excessive cross-voltage. Furthermore, when the input voltage is present while the power supply voltage is absent, the control transistor is turned off due to the same voltage at its two terminals, and thus the voltage will not backfeed to the power supply voltage path.

It should be noted that people having ordinary skill in the art can selectively use some or all of the features of any embodiment in this specification or selectively use some or all of the features of multiple embodiments in this specification to implement the present invention as long as such implementation is practicable; in other words, the way to implement the present invention can be flexible based on the present disclosure.

The descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A receiver protection device, comprising:
a bias circuit, configured to receive an input voltage, and generate a plurality of bias voltages according to the input voltage; and
a first protection circuit, comprising:
a first control transistor, configured to receive a power supply voltage, provide the power supply voltage or a low-level voltage to be a first control voltage according to a first bias voltage of the plurality of bias voltages, and provide the first control voltage to a first node;
a first diode, configured to provide a first output voltage to the first node according to a second bias voltage of the plurality of bias voltages; and
a first protection transistor, configured to receive the input voltage, and provide the input voltage or the low-level voltage to be a protection voltage according to a first voltage of the first node.

2. The receiver protection device of claim 1, wherein a voltage difference between the power supply voltage and the first bias voltage is less than the power supply voltage.

3. The receiver protection device of claim 1, wherein the first output voltage is the same as the first bias voltage.

4. The receiver protection device of claim 1, further comprising:
a second protection circuit, comprising:
a second control transistor, configured to receive the power supply voltage, and provide the power supply voltage or the low-level voltage to be a second control voltage according to the first bias voltage of the plurality of bias voltages;
a third control transistor, configured to receive the second control voltage, and provide the second control voltage to a second node according to a third bias voltage of the plurality of bias voltages;
a second diode, configured to provide a second output voltage to the second node according to a fourth bias voltage of the plurality of bias voltages; and
a second protection transistor, configured to receive the input voltage, and provide the input voltage to the low-level voltage to be the protection voltage according to a second voltage of the second node.

5. The receiver protection device of claim 4, wherein a first voltage difference between the power supply voltage and the first bias voltage is less than the power supply voltage, and a second voltage difference between the first bias voltage and the third bias voltage is less than the power supply voltage.

6. The receiver protection device of claim 4, wherein the second output voltage is the same as the third bias voltage.

7. The receiver protection device of claim 4, further comprising:
a third protection circuit, comprising:
a fourth control transistor, configured to receive the power supply voltage, and provide the power supply voltage or the low-level voltage to be a third control voltage according to the first bias voltage of the plurality of bias voltages;
a fifth control transistor, configured to receive the third control voltage, and provide the third control voltage according to the third bias voltage of the plurality of bias voltages;
a sixth control transistor, configured to receive the third control voltage, and provide the third control voltage to a third node according to a fifth bias voltage of the plurality of bias voltages;
a third diode, configured to provide a third output voltage to the third node according to a sixth bias voltage of the plurality of bias voltages; and
a third protection transistor, configured to receive the input voltage, and provide the input voltage or the low-level voltage to be the protection voltage according to a third voltage of the third node.

8. The receiver protection device of claim 7, wherein a first voltage difference between the power supply voltage and the first bias voltage is less than the power supply voltage, a second voltage difference between the first bias voltage and the third bias voltage is less than the power supply voltage, and a third voltage difference between the third bias voltage and the fifth bias voltage is less than the power supply voltage.

9. The receiver protection device of claim 7, wherein the third output voltage is the same as the fifth bias voltage, wherein voltage magnitudes of the first bias voltage to the sixth bias voltage sequentially increase from low to high.

10. The receiver protection device of claim 1, further comprising:
a switch transistor, connected in series to the first protection transistor, and provide the protection voltage or the low-level voltage to a receiver according to a switch voltage.
